(19) United States
(12) Patent Application Publication
(10) Pub. No.: US 2026/0109587 A1
(43) Pub. Date: Apr. 23, 2026

(54) Vented Funnel Device

(71) Applicant: Tucker Johnson, Ramer, AL (US)

(72) Inventor: Tucker Johnson, Ramer, AL (US)

(21) Appl. No.: 19/342,785

(22) Filed: Sep. 29, 2025

Related U.S. Application Data
(60) Provisional application No. 63/709,047, filed on Oct. 18, 2024.

(51) Int. Cl. B67C 11/02; B67C 11/00

(52) U.S. Cl. CPC B67C 11/02; B67C 2011/30

(57) ABSTRACT

The device is comprised of a funnel body that may adopt various shapes such as conical, cylindrical, or parabolic, each offering distinct liquid flow characteristics. The body can be made from materials like stainless steel for durability or BPA-free plastic for chemical resistance, with options for heat-resistant materials like silicone or borosilicate glass. The exterior surface is designed for improved grip, featuring textures such as ridges or grooves, and may include materials like non-slip rubber for enhanced handling. The body comprises a first end with an outward lip to prevent spillage and a tapered second end for precise liquid flow. Measurement markings inside the funnel aid in accurate pouring, while a vent opening parallel to the main opening allows air to escape, optimizing flow by preventing air pressure buildup and ensuring smooth liquid transfer.

### CROSS-REFERENCE TO RELATED APPLICATION

The present application claims priority to, and the benefit of, U.S. Provisional Application No. 63/709,047, which was filed on Oct. 18, 2024, and is incorporated herein by reference in its entirety.

### FIELD OF THE INVENTION

The present invention relates generally to the field of funnels. More specifically, the present invention relates to a vented funnel device comprised of a funnel body with a vent opening that allows air to vent from a receptacle while pouring a liquid into said receptacle via the device. Accordingly, the present disclosure makes specific reference thereto. Nonetheless, it is to be appreciated that aspects of the present invention are also equally applicable to other like applications, devices, and methods of manufacture.

### BACKGROUND

When pouring oil or other fluids through a funnel, the filling process can become quite slow, especially when dealing with larger quantities of liquid. This is due to the lack of proper pressure relief within the funnel, which restricts the flow of the fluid and causes it to back up. As a result, the fill time can be excessively long and inefficient. Users may try to speed up the process by lifting the funnel to allow air to escape, creating pressure relief. However, doing so often leads to fluid spilling over the sides, causing not only a mess but also a waste of valuable product. This situation is both frustrating and inconvenient, as it increases the time needed to complete the task and leads to unnecessary loss of fluid, which could otherwise be used more effectively. Additionally, the risk of spills can create safety hazards in certain environments, especially when working with hazardous or slippery substances like oil. This problem highlights the need for a more efficient method of dispensing fluids through a funnel without compromising speed, safety, or product waste.

Therefore, there exists a long-felt need in the art for an improved funnel. There also exists a long-felt need in the art for a vented funnel device. More specifically, there exists a long-felt need in the art for a vented funnel device that increases flow rate. Further, there exists a long-felt need in the art for a vented funnel device that increases flow rate via relieving pressure in a manner that does not pose the risk of fluid leaking from the funnel.

The subject matter disclosed and claimed herein, in one embodiment thereof, comprises a vented funnel device. The device is comprised of a funnel body that may adopt various shapes such as conical, cylindrical, or parabolic, each offering distinct liquid flow characteristics. The body can be made from materials like stainless steel for durability or BPA-free plastic for chemical resistance, with options for heat-resistant materials like silicone or borosilicate glass. The exterior surface is designed for improved grip, featuring textures such as ridges or grooves, and may include materials like non-slip rubber for enhanced handling. The body comprises a first end with an outward lip to prevent spillage and a tapered second end for precise liquid flow. Measurement markings inside the funnel aid in accurate pouring, while a vent opening parallel to the main opening allows air to escape, optimizing flow by preventing air pressure buildup and ensuring smooth liquid transfer.

In this manner, the vented funnel device of the present invention accomplishes all the foregoing objectives and provides an improved funnel. More specifically, the device increases the flow rate. Further, the device increases the flow rate by relieving pressure in a manner that does not pose the risk of fluid leaking from the funnel.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a vented funnel device. The device is comprised of a funnel body that can adopt various shapes, including conical, cylindrical, or parabolic forms, each designed for specific liquid flow characteristics. The conical shape supports gradual, even flow, while the cylindrical shape ensures consistent pouring of thicker liquids. The parabolic form minimizes splashing by focusing the liquid into a concentrated stream. The body may be made from durable materials such as stainless steel, resistant to corrosion, or lightweight, BPA-free plastic. In alternative embodiments, heat-resistant materials such as silicone or borosilicate glass are used, allowing the device to handle hot liquids like oils or melted substances.

The exterior surface of the funnel body may incorporate textured patterns, such as raised ridges or grooves, to improve the user's grip during operation. These textures may follow the contours of the funnel, providing tactile feedback, and enhancing handling in wet conditions. Recessed patterns, like indentations or honeycomb structures, may also be used to increase friction. The surface can be made from the same material as the body for uniformity or from a different material, such as thermoplastic elastomer or non-slip rubber, to provide a soft-touch finish and reduce slippage.

The funnel body features a first end with an outwardly extending lip designed to prevent liquid spillage by guiding the flow inward toward a tapered opening. The lip may include an outward flare to redirect drips back into the funnel, especially useful for viscous liquids. The opening extends from the first to the second end, tapering from a wider first diameter to a smaller second diameter, which allows for precise control of the liquid flow and creates a focused stream at the second end.

The funnel opening may include measurement markings that are etched, printed, or molded into the inner surface to provide a visual reference for liquid volume. These markings are arranged in graduated increments, such as milliliters or fluid ounces, ensuring accurate pouring. In some embodiments, the markings are raised to prevent wear over time.

Additionally, the funnel body is comprised of at least one vent opening running parallel to the main opening. This vent allows air to escape as the liquid is poured, preventing air pressure buildup that could hinder smooth flow. The vent opening may be narrower than the main opening to balance air pressure without interfering with liquid transfer, improving efficiency, especially when handling denser liquids such as syrups or oils. This design prevents backflow or glugging effects caused by trapped air.

Accordingly, the vented funnel device of the present invention is particularly advantageous as it provides an improved funnel. More specifically, the device increases the flow rate. Further, the device increases the flow rate by relieving pressure in a manner that does not pose the risk of fluid leaking from the funnel. In this manner, the vented funnel device overcomes the limitations of existing funnels known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a vented funnel device of the present invention in accordance with the disclosed architecture; and

FIG. 2 illustrates a cross-sectional side view of one potential embodiment of a vented funnel device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved funnel. There also exists a long-felt need in the art for a vented funnel device. More specifically, there exists a long-felt need in the art for a vented funnel device that increases flow rate. Further, there exists a long-felt need in the art for a vented funnel device that increases flow rate via relieving pressure in a manner that does not pose the risk of fluid leaking from the funnel.

The present invention, in one exemplary embodiment, is comprised of a vented funnel device. The device is comprised of a funnel body that may take various shapes, including conical, cylindrical, or parabolic forms, each tailored to optimize liquid flow. The conical shape facilitates gradual, even flow, while the cylindrical form supports consistent pouring of thicker liquids. The parabolic shape reduces splashing by concentrating the liquid into a focused stream. The body can be made from materials such as corrosion-resistant stainless steel or lightweight, BPA-free plastic. In alternative embodiments, heat-resistant materials like silicone or borosilicate glass enable the device to handle hot liquids, such as oils or melted substances.

The exterior surface of the funnel body may include textured patterns, such as raised ridges or grooves, to enhance the user's grip during use. These textures may follow the funnel's contours to provide tactile feedback and improve handling in wet conditions. Recessed patterns, such as indentations or honeycomb structures, may also be applied to increase friction. The surface can be made from the same material as the body for consistency or from materials like thermoplastic elastomer or non-slip rubber to offer a soft-touch finish and minimize slippage.

The funnel body is equipped with a first end featuring an outwardly extending lip that prevents spillage by guiding liquid inward toward a tapered opening. This lip may have an outward flare to redirect drips back into the funnel, particularly useful for thicker liquids. The opening runs from the first end to the second end, tapering from a wider first diameter to a narrower second diameter, enabling precise control over liquid flow and forming a focused stream at the second end.

The funnel opening may include measurement markings, which can be etched, printed, or molded into the inner surface to provide a visual indication of liquid volume. These markings are arranged in graduated increments, such as milliliters or fluid ounces, to ensure accurate pouring. In some versions, the markings are raised to prevent fading from contact with liquids or cleaning.

Additionally, the funnel body features at least one vent opening running parallel to the main opening. This vent allows air to escape during pouring, preventing pressure buildup that could impede liquid flow. The vent opening may be narrower than the main opening to balance air pressure without disrupting liquid transfer, improving efficiency, especially for denser liquids like syrups or oils. This design helps prevent backflow or glugging caused by trapped air.

The vented funnel device offers improved performance by increasing the flow rate while preventing fluid leakage. By relieving pressure efficiently, the device addresses the shortcomings of conventional funnels.

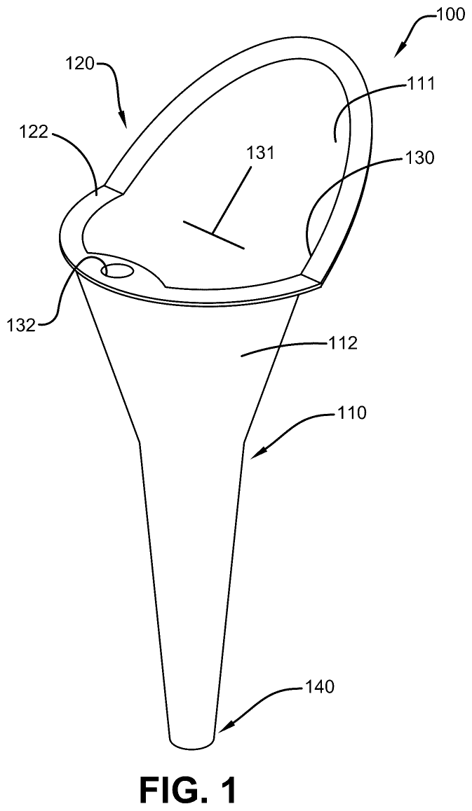

Referring initially to the drawings, FIG. 1 illustrates a perspective view of one potential embodiment of a vented funnel device 100 of the present invention in accordance with the disclosed architecture. The device 100 is comprised of a funnel body 110, which may take various funnel shapes, including, but not limited to, conical, cylindrical, or parabolic forms. The conical shape may provide a gradual and even flow of liquid, while a cylindrical shape supports consistent pouring for thicker liquids. A parabolic shape minimizes splashing by focusing the liquid into a concentrated stream. The body 110 may be manufactured from materials such as stainless steel, offering durability and resistance to corrosion, or high-grade BPA-free plastic, which provides lightweight handling and chemical resistance. In an alternative embodiment, the funnel body 110 is made from heat-resistant materials, such as silicone or borosilicate glass, capable of withstanding high temperatures, making the device suitable for pouring hot liquids like oils or melted substances.

The exterior surface 112 of the body 110 may be comprised of a texture designed to enhance the user's grip during operation. The texture may include raised patterns such as ridges or grooves that follow the contour of the body 110, offering tactile feedback and improving handling under wet conditions. Alternatively, the surface 112 may feature recessed patterns, such as indentations or honeycomb structures, to increase friction between the hand and the funnel. These textures may be symmetrically or asymmetrically distributed across the exterior surface 112 for forming targeted grip zones. The exterior surface 112 may be made from the same material as the body 110, maintaining uniformity in construction, or it may be made from a different material, such as a thermoplastic elastomer, to enhance grip. In one embodiment, the exterior surface 112 is comprised of a non-slip rubber, providing a soft-touch finish that reduces the likelihood of slippage.

The body 110 is further comprised of a first end 120, which includes an outwardly extending lip 122. This lip 122 is engineered to create a barrier that prevents liquid from spilling over the edge of the first end 120, guiding the flow inward toward the opening 130. The lip 122 may feature an outward flare, redirecting any errant drips back into the funnel body 110, which is particularly useful when pouring viscous liquids. The body 110 is also comprised of a second end 140, wherein an opening 130 extends from the first end 120 to the second end 140. The opening 130 is wider (i.e., of a larger, first diameter) at the first end 120 and gradually tapers toward a smaller, second diameter at the second end 140. This tapering design aids in controlling the flow rate and precision of liquid transfer, as the reduction in diameter at the second end 140 creates a focused stream.

The opening 130 may also be comprised of at least one measurement marking 131, which can be etched, printed, or molded directly into the inner surface 111 of the funnel body 110, as seen in FIG. 1. The measurement markings 131 provide the user with a visual indicator of liquid volume as it is funneled through the device 100. The markings 131 may be positioned in graduated increments (e.g., milliliters, fluid ounces) to facilitate accurate pouring. In one embodiment, the markings 131 are raised to prevent fading over time due to contact with liquids or cleaning agents.

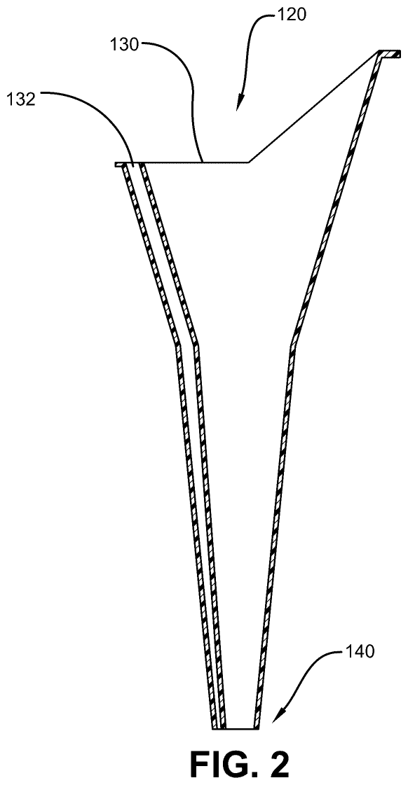

Additionally, the body 110 is comprised of at least one vent opening 132, which is strategically positioned to run parallel to the main opening 130. The vent opening 132 extends from the first end 120 to the second end 140 (as seen in FIG. 2), allowing air to escape from the receiving container as liquid enters, thereby improving the flow rate. This venting feature prevents the buildup of air pressure, which could otherwise impede the smooth passage of liquid. In some configurations, the vent opening 132 may be narrower than the main opening 130, designed to balance air pressure without affecting the overall liquid flow. This improves efficiency when pouring denser liquids, such as syrups or oils, by preventing backflow or glugging effects commonly caused by trapped air.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “vented funnel device” and “device” are interchangeable and refer to the vented funnel device 100 of the present invention.

Notwithstanding the foregoing, the vented funnel device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the vented funnel device 100 as shown in the FIGS. are for illustrative purposes only, and that many other sizes and shapes of the vented funnel device 100 are well within the scope of the present disclosure. Although the dimensions of the vented funnel device 100 are important design parameters for user convenience, the vented funnel device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A vented funnel device comprising:
a funnel body comprised of a first end and a second end, the funnel body comprised of:
a lip positioned at the first end;
a vent opening; and
an opening extending from the first end to the second end, the opening having a first diameter at the first end and a second diameter at the second end.

2. The vented funnel device of claim 1, wherein the lip is comprised of a flared lip.

3. The vented funnel device of claim 1, wherein the body is comprised of a conical shape.

4. The vented funnel device of claim 1, wherein an inner surface of the body is comprised of a measurement marking.

5. The vented funnel device of claim 4, wherein the measurement marking is comprised of a raised marking.

6. The vented funnel device of claim 1, wherein the body is comprised of a stainless steel.

7. The vented funnel device of claim 1, wherein the body is comprised of a plastic.

8. A vented funnel device comprising:
a funnel body comprised of a first end and a second end, the funnel body comprised of:
a lip positioned at the first end;
an exterior surface comprised of a texture;
a vent opening; and
an opening extending from the first end to the second end, the opening having a first diameter at the first end and a second diameter at the second end.

9. The vented funnel device of claim 8, wherein the body is comprised of a cylindrical shape.

10. The vented funnel device of claim 8, wherein the texture is comprised of a groove.

11. The vented funnel device of claim 8, wherein the texture is comprised of a ridge.

12. The vented funnel device of claim 8, wherein the texture is comprised of a recessed indentation.

13. The vented funnel device of claim 8, wherein the texture is comprised of a honeycomb structure.

14. The vented funnel device of claim 8, wherein the exterior surface is comprised of a rubber material.

15. The vented funnel device of claim 8, wherein the texture is symmetrically distributed across the exterior surface.

16. The vented funnel device of claim 8, wherein the texture is asymmetrically distributed across the exterior surface.

17. The vented funnel device of claim 8, wherein the exterior surface is comprised of a thermoplastic elastomer.

18. A vented funnel device comprising:
a funnel body comprised of a first end and a second end, the funnel body comprised of:
a lip positioned at the first end;
an exterior surface comprised of a texture;
an opening extending from the first end to the second end, the opening having a first diameter at the first end and a second diameter at the second end; and
a vent opening parallel to the opening.

19. The vented funnel device of claim 18, wherein the body is comprised of a parabolic shape.

20. The vented funnel device of claim 18, wherein the opening is smaller than the vent opening.
